(19) United States
(12) Patent Application Publication
(10) Pub. No.: US 2025/0351766 A1
(43) Pub. Date: Nov. 20, 2025

(54) SYSTEM AND METHOD FOR AN AUTOMATIC SEEDER APPARATUS

(71) Applicant: URBAN KISAAN FARMS PRIVATE LIMITED [IN]/[IN], Hyderabad (IN)

(72) Inventors: Vihari PALICHERLA KANUKOLLU, Hyderabad (IN); Sairam PALICHERLA REDDY, Hyderabad (IN); Phanindra SARMA, Hyderabad (IN); Kishore KUMAR.Y, Hyderabad (IN); Anand YARAM BABU, Hyderabad (IN)

(73) Assignee: URBAN KISAAN FARMS PRIVATE LIMITED [IN]/[IN], Hyderabad (IN)

(21) Appl. No.: 19/215,484

(22) Filed: May 22, 2025

(30) Foreign Application Priority Data
Nov. 22, 2022 (WO) PCT/IN2023/051075

(51) Int. Cl. A01C 7/10; A01C 7/08

(52) U.S. Cl. CPC A01C 7/105; A01C 7/088

(57) ABSTRACT

The various embodiments of the present invention provide a system and method for enabling an automatic seeder apparatus. The embodiments also provide a system and method for providing a portable seeder apparatus that does not entail any specific additional external mechanism for its operation. The system comprises a gravity-based seed dispensing system that enables a completely automatic seeder apparatus without any manual operations such as seed-feeding or alignment. The system comprises a conveyor, a seeder machine stand, a hopper, a seed dispensing tray with a hole seat, a bottom tray with holes, a seeding tray sensing sensor, a solenoid plunger, and a control box. The system enables a portable tabletop seeder apparatus that does not require any additional external mechanisms such as vacuum arrangements, air compressors, or any other mechanical push-pull mechanisms for its functioning.

### CROSS-REFERENCE TO RELATED APPLICATIONS

This patent application claims the priority of the Indian Provisional Patent Application filed on 22 Nov. 2022, with the number 202241066960, which was also filed as PCT/IN2023/051075 filed on 22 Nov. 2022.

### FEDERALLY SPONSORED RESEARCH AND DEVELOPMENT

Not applicable

### FIELD OF INVENTION

The present invention is generally related to the seeding process in agriculture operations. The present invention is particularly related to a system and method for enabling an automatic seeder apparatus.

### BACKGROUND OF THE INVENTION

Seeding is one of the most fundamental and important processes in agriculture. There are a wide variety of seed dispensing machines currently available, and they can be classified based on their complexity and operating principles, such as vacuum seed dispensing machine, vacuum box, and vacuum rotating drum machine.

Vacuum seed dispensing machines operate with vacuum, and a simple vacuum seeding machine is a handle with holes. The operator immerses this vacuum handle to pick seeds from a container. Upon picking up, the operator aligns with seeding tray holes and releases vacuum, then the seeds drop into seeding tray.

Vacuum box consists of a vacuum box with 92 holes, where a human operator pours seeds over the holes and then tilts it to-and-fro so that the seeds fall into the hole seats. The operator then flips the vacuum box over the seeding tray to release the vacuum, and the seeds fall into seeding tray. All the operations are manual and need air compressor machine.

While in a vacuum rotating drum machine the operations are automatic, is a big and bulky machine which is not portable. It also needs an air compressor for its working.

Hence, there exists a need for a seeder apparatus that is automated and does not involve any manual operations. There also exists a need for a system and method for providing a portable seeder apparatus that does not entail any specific additional external mechanism for its working.

The abovementioned shortcomings, disadvantages and problems are addressed herein, which will be understood by reading and studying the following specification.

### SUMMARY OF THE INVENTION

### Object of the Invention

The primary object of the present invention is to provide a system and method for enabling an automatic seeder apparatus.

Another object of the present invention is to provide a system and method for providing a portable seeder apparatus that does not entail any specific additional external mechanism for its working.

Yet another object of the present invention is to provide a system for enabling an automatic table-top seeder apparatus.

Yet another object of the present invention is to provide a gravity-based seed dispensing system for enabling an automatic seeder apparatus.

Yet another object of the present invention is to provide a completely automatic seeder system and method without any manual operations such as seed-feeding or alignment.

Yet another object of the present invention is to provide a portable table-top seeder apparatus that does not require any additional external mechanism such as vacuum arrangements, air compressors or any other mechanical push-pull mechanisms for its functioning.

These and other objects and advantages of the present invention will become readily apparent from the following detailed description taken in conjunction with the accompanying drawings.

The various embodiments of the present invention provide a system and method for enabling an automatic seeder apparatus. The embodiments also provide a system and method for providing a portable seeder apparatus that does not entail any specific additional external mechanism for its working.

According to one embodiment of the present invention, a system for enabling an automatic table-top seeder apparatus is provided. The system comprises a conveyer, a seeder machine stand, a hopper, a seed dispensing tray with hole seat, a bottom tray with holes, a seeding tray sensing sensor, a solenoid plunger and a control box. The seeding tray is placed on the conveyer, wherein the machine senses the seeding tray and the conveyer moves by an indexed step. The solenoid plunger then pushes the seed dispensing tray, where the seeds are already loaded in hole seats by gravity. When the hole seats are aligned with holes in the bottom tray, the seeds fall into the seeding tray as this alignment paves the way for the seeds to fall into seeding tray. The conveyer then moves to a next indexed position and the process repeats until the seeding tray is fully seeded.

According to one embodiment of the present invention, a gravity-based seed dispensing system is provided. A plurality of seeds are stored in a hopper, wherein the seeds are provided to seed a plurality of seeding trays. Beneath the hopper, a seed dispensing system is provided, which comprises a seed dispensing tray with hole seats and a hole tray provided in sliding arrangement. When the solenoid plunger moves the seed dispensing tray with hole seats, it aligns with hole tray at the bottom which paves the way for the seeds to fall into seeding tray due to gravity.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The other objects, features and advantages will occur to those skilled in the art from the following description of the preferred embodiment and the accompanying drawings in which:

FIG. 1 illustrates the top-view of a system for enabling an automatic seeder apparatus, according to one embodiment of the present invention.

FIG. 2 illustrates the isometric view of a system for enabling an automatic seeder apparatus, according to one embodiment of the present invention.

FIG. 3 illustrates a seeding machine that enables a portable seeder apparatus that does not entail any specific additional external mechanism for its working, according to one embodiment of the present invention.

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments of the present invention provide a system and method for enabling an automatic seeder apparatus. The embodiments also provide a system and method for providing a portable seeder apparatus that does not entail any specific additional external mechanism for its working.

According to one embodiment of the present invention, a system for enabling an automatic table-top seeder apparatus is provided. The system comprises a conveyer, a seeder machine stand, a hopper, a seed dispensing tray with hole seat, a bottom tray with holes, a seeding tray sensing sensor, a solenoid plunger and a control box. The seeding tray is placed on the conveyer, wherein the machine senses the seeding tray and the conveyer moves by an indexed step. The Solenoid Plunger then pushes the seed dispensing tray, where the seeds are already loaded in hole seats by gravity. When the hole seats are aligned with holes in the bottom tray, the seeds fall into the seeding tray as this alignment paves the way for the seeds to fall into seeding tray. The conveyer then moves to a next indexed position and the process repeats until the seeding tray is fully seeded. According to an embodiment the seeder apparatus is configured to work with varied types of seed trays. According to an embodiment the seeder apparatus is configured to work with varied dimensions of seed trays.

According to one embodiment of the present invention, a gravity-based seed dispensing system is provided. A plurality of seeds are stored in a hopper, wherein the seeds are provided to seed a plurality of seeding trays. According to an embodiment, the hopper has the storage capacity to seed fifty seeding trays. Beneath the hopper, a seed dispensing system is provided, which comprises a seed dispensing tray with hole seats and a hole tray provided in sliding arrangement. When the solenoid plunger moves the seed dispensing tray with hole seats, it aligns with hole tray at the bottom which paves the way for the seeds to fall into seeding tray due to gravity.

According to one embodiment of the present invention, a system is provided for enabling an automatic gravity-based seeder apparatus. The system comprises a seeding machine; a conveyer; a seeder machine stand; a hopper for storing seeds; a seed dispensing tray with hole seats; a bottom tray with holes; a seeding tray sensing sensor; a solenoid plunger; and a control box. The seeding tray is placed on the conveyer, the conveyer moves by an indexed step upon sensing the seeding tray, and the solenoid plunger pushes the seed dispensing tray when hole seats align with holes in the bottom tray, allowing seeds to fall into the seeding tray.

According to one embodiment of the present invention, the conveyer moves to a next indexed position after the seeds fall into the seeding tray, and the process repeats until the seeding tray is fully seeded. The seeder apparatus is portable, and is operable based on gravity and does not require any additional external mechanism such as vacuum arrangements, air compressors, or mechanical push-pull mechanisms for its functioning. The control box regulates the operation of the conveyer, solenoid plunger, and seeding tray sensing sensor. The seeder machine stand provides stability to the system during operation, and wherein, the seeding tray sensing sensor is configured to detect the presence of the seeding tray on the conveyer.

According to one embodiment of the present invention, a method is provided for enabling an automatic gravity-based seeder apparatus. The method includes: placing a seeding tray on a conveyer; sensing the seeding tray with a seeding tray sensing sensor; moving the conveyer by an indexed step upon sensing the seeding tray; pushing a seed dispensing tray with hole seats using a solenoid plunger; allowing seeds to fall into the seeding tray when hole seats align with holes in a bottom tray; moving the conveyer to a next indexed position; and, repeating the process until the seeding tray is fully seeded. The method further comprises the step of monitoring and controlling the seeder apparatus through the control box.

According to one embodiment of the present invention, the conveyer moves to a next indexed position after the seeds fall into the seeding tray, and the process repeats until the seeding tray is fully seeded. The seeding tray sensing sensor detects the presence of the seeding tray on the conveyer, and thereby triggering the subsequent steps in the seeding process.

### Advantages of the Invention

The various embodiments of the present invention provide a system and method for enabling an automatic seeder apparatus. The embodiments also provide a system and method for providing a portable seeder apparatus that does not entail any specific additional external mechanism for its working. The embodiments provide a completely automatic seeder system and method without any manual operations such as seed-feeding or alignment. The embodiments provide a portable table-top seeder apparatus that does not require any additional external mechanism such as vacuum arrangements, air compressors or any other mechanical push-pull mechanisms for its functioning.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

### DETAILED DESCRIPTION OF THE FIGURES

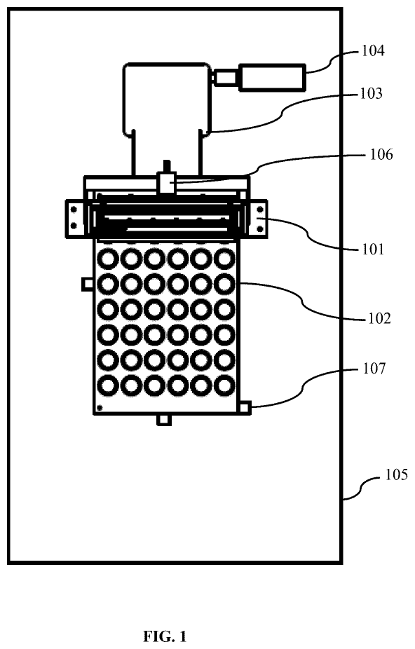

FIG. 1 illustrates the top-view of a system for enabling an automatic seeder apparatus. The system comprises a seeding machine 101, a seeding tray 102, a conveyer 103, a motor 104, a stand arrangement 105, a solenoid arrangement 106 and a plurality of guiders 107.

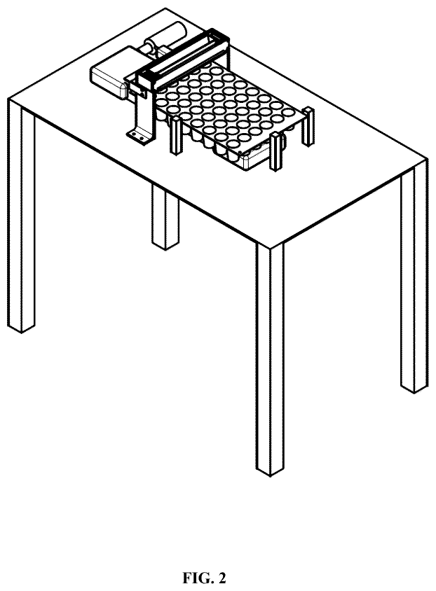

FIG. 2 illustrates the isometric view of a system for enabling an automatic seeder apparatus.

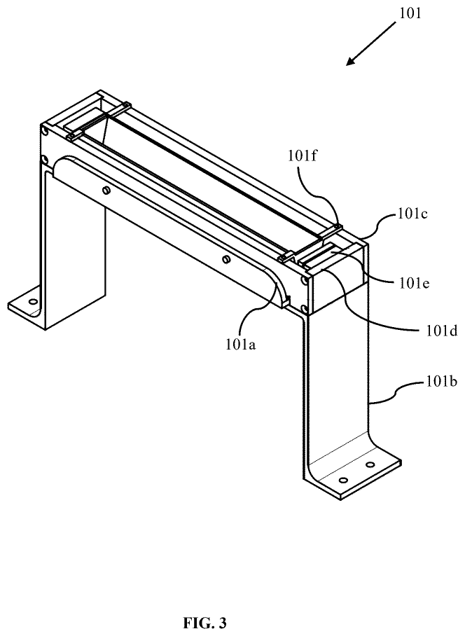

FIG. 3 illustrates a seeding machine that enables a portable seeder apparatus that does not entail any specific additional external mechanism for its working. The seeding machine comprises a seed tray 101a, a base tray 101b, a front wall 101c, a slider guide 101d, a slider 101e and a seed hopper 101f.

Although the embodiments herein are described with various specific embodiments, it will be obvious for a person skilled in the art to practice the embodiments herein with modifications.

1. A system for enabling an automatic gravity-based seeder apparatus, the system comprising:
a seeding machine;
a conveyer;
a seeder machine stand;
a hopper for storing seeds;
a seed dispensing tray with hole seats;
a bottom tray with holes;
a seeding tray sensing sensor;
a solenoid plunger; and
a control box,
wherein the seeding tray is placed on the conveyer, the conveyer moves by an indexed step upon sensing the seeding tray, and the solenoid plunger pushes the seed dispensing tray when hole seats align with holes in the bottom tray, allowing seeds to fall into the seeding tray.

2. The system according to claim 1, wherein the conveyer moves to a next indexed position after the seeds fall into the seeding tray, and the process repeats until the seeding tray is fully seeded.

3. The system according to claim 1, wherein the seeder apparatus is portable, and is operable based on gravity and does not require any additional external mechanism such as vacuum arrangements, air compressors, or mechanical push-pull mechanisms for its functioning.

4. The system according to claim 1, wherein the control box regulates the operation of the conveyer, solenoid plunger, and seeding tray sensing sensor.

5. The system according to claim 1, wherein the seeder machine stand provides stability to the system during operation, and wherein, the seeding tray sensing sensor is configured to detect the presence of the seeding tray on the conveyer.

6. The system according to claim 1, wherein the solenoid plunger pushes the seed dispensing tray, where the seeds are already loaded in hole seats by gravity.

7. A method for enabling an automatic gravity-based seeder apparatus, the method including:
placing a seeding tray on a conveyer;
sensing the seeding tray with a seeding tray sensing sensor;
moving the conveyer by an indexed step upon sensing the seeding tray;
pushing a seed dispensing tray with hole seats using a solenoid plunger;
allowing seeds to fall into the seeding tray when hole seats align with holes in a bottom tray;
moving the conveyer to a next indexed position; and,
repeating the process until the seeding tray is fully seeded.

8. The method according to claim 7, wherein the conveyer moves to a next indexed position after the seeds fall into the seeding tray, and the process repeats until the seeding tray is fully seeded.

9. The method according to claim 7, wherein the method further comprises the step of monitoring and controlling the seeder apparatus through the control box.

10. The method according to claim 7, wherein the seeding tray sensing sensor detects the presence of the seeding tray on the conveyer, and thereby triggering the subsequent steps in the seeding process.
